(19) United States
(12) Patent Application Publication
(10) Pub. No.: US 2011/0150283 A1
(43) Pub. Date: Jun. 23, 2011

(54) APPARATUS AND METHOD FOR PROVIDING ADVERTISING CONTENT

(75) Inventors: Do-Hyung KIM, Daejeon (KR); Bon-Ki Koo, Daejeon (KR)

(73) Assignee: Electronics and Telecommunications Research Institute, Daejeon (KR)

(21) Appl. No.: 12/970,596

(22) Filed: Dec. 16, 2010

(30) Foreign Application Priority Data
Dec. 18, 2009 (KR) 10-2009-0126715
Mar. 17, 2010 (KR) 10-2010-0023633

(51) Int. Cl. G06K 9/00

(52) U.S. Cl. 382/103

(57) ABSTRACT

Disclosed herein are an apparatus and method for providing advertising content effectively. The apparatus for providing advertising content comprises: a image processing unit for extracting an object from a captured image; the long-distance analysis unit for creating long-distance analysis information obtained by analyzing the object at a first distance; the short-distance analysis unit for creating short-distance analysis information obtained by analyzing the object at a second distance that is shorter than the first distance; and the content selection unit for selecting advertising content using the long-distance analysis information and the short-distance analysis information.

### CROSS REFERENCE TO RELATED APPLICATIONS

This application claims the benefit of Korean Patent Application No. 10-2009-0126715 filed on Dec. 18, 2009, and Korean Patent Application No. 10-2010-0023633 filed on Mar. 17, 2010, which are hereby incorporated by reference in their entirety into this application.

### BACKGROUND OF THE INVENTION

1. Technical Field

The present invention relates generally to technology for searching for and providing object-related advertising content, and, more particularly, to technology for extracting the age, gender and direction of the eyes related to advertising content of an object based on an image of the object, determining the age, gender and interest in advertising content of the object based on the extracted information, and providing advertising content, thereby increasing the advertising effect.

The present invention was conceived of during the course of research that was conducted as part of a fundamental information technology development project that was sponsored by the Korean Ministry of Culture, Sports and Tourism [Task Administration Number: 2008-F-030-02; Title of Task: Development of Broadcasting-Communication Convergence Full 3D Recovery Technology].

2. Description of the Related Art

The purpose of advertising is to attract users' attention to an advertisement and to stimulate the users' desire to purchase the products. Accordingly, recently, research into technology for more effectively providing advertising content to users has been conducted.

A principal factor in the provision of an advertisement is to attract users' attention. Accordingly, in the field related to the technology for effectively providing an advertisement, the demand for technology that analyzes user information and then provides advertising content in which users may be interested is increasing.

Advertisements provided in response to user information are referred to as interactive advertisements. Interactive advertisements are accepted as more effective than conventional advertisements. Using interactive advertisements, users can control the advertising information in an active manner, and selectively learn information suitable for them. Furthermore, it is possible to increase unintentional royalty to advertisements using the interaction between the users and the provision of the advertisements. Besides, interactive advertisements have the effect of increasing the familiarity and intimacy with advertising targets through the interaction with the advertisements.

Accordingly, interactive technology is attracting attention as a technology for effectively providing advertising content. Thus, the demand for technology for, in connection with interactive advertisement, accurately analyzing users and providing advertising content in response to user information is increasing.

The term “user information” refers to the interest, gender and age of a user. Accordingly, the core technology of the technology for providing advertising content is a technology that analyzes the interest, gender and age of a user and provides appropriate advertising content.

A representative technology that analyzes user information is a technology that receives a camera image and processes the image. However, this technology is simply based on one or more still images of a user captured within a predetermined distance range, the demand for technology for more accurately analyzing users is increasing.

### SUMMARY OF THE INVENTION

The present invention has been made keeping in mind the above problems occurring in the prior art, and an object of the present invention is to provide a method and an apparatus which is capable of, in connection with technology for providing advertising content to users using the interaction with the users, accurately analyzing user information and then allowing advertising content to be selected in response to the user information. More particularly, an object of the present invention is to provide a method and an apparatus which can analyze dynamic user information, such as the actions and direction of eyes of a user, in addition to still images of the user, provide a user-customized advertisement, and dynamically provide advertising content in response to the action of the user and the results of the analysis varying in real time.

In order to accomplish the above object, the present invention provides an apparatus for providing advertising content, comprising an image processing unit for extracting an object from a captured image; a long-distance analysis unit for creating long-distance analysis information obtained by analyzing the object at a first distance; a short-distance analysis unit for creating short-distance analysis information obtained by analyzing the object at a second distance shorter than the first distance; and a content selection unit for selecting an advertising content based on the long-distance analysis information and the short-distance analysis information.

The long-distance analysis information may include one or more of trajectory information of the object and second eye direction information. The long-distance analysis information may further include information about the relationship between previously created trajectory information of a plurality of objects and previously created gender and age information of the plurality of objects, and information about the gender and age of the object based on the information about a relationship. In contrast, the short-distance analysis information may include one or more of information about the face of the object, information about the gender of the object, information about the age of the object, and first eye direction information.

The content selection unit may comprise the functionality of selecting another piece of advertising content if the first or second eye direction information indicates that the time for which the direction of eyes has deviated from the direction toward the advertising content exceeds a predetermined time.

The content selection unit may comprise the functionality of primarily selecting first advertising content based on the long-distance analysis information and, when the short-distance analysis information is created, selecting second advertising content based on the short-distance analysis information.

The first eye direction information may be created based on one or more of the direction of the face of the object and the direction of irises of the object. In contrast, the second eye direction information may be created based on one or more of a direction of a front of the upper body of the object and a direction of a front of the face of the object.

Furthermore, a user input unit for enabling interaction with the object to select advertising content may be connected to the content selection unit.

In order to accomplish the above object, the present invention provides a method of providing advertising content, comprising creating long-distance analysis information obtained by analyzing at least one object extracted from an image at a first distance, by a long-distance analysis unit; creating short-distance analysis information obtained by analyzing the object at a second distance shorter than the first distance, by a short-distance analysis unit; and selecting advertising content using the long-distance analysis information and the short-distance analysis information, by a content selection unit.

The short-distance analysis information may include one or more of information about the face of the object, information about the gender of the object, information about the age of the object, and first eye direction information. The long-distance analysis information includes one or more of the trajectory information of the object and second eye direction information. The long-distance analysis information may further include information about the relationship between the previously created trajectory information of a plurality of objects and the previously created gender and age information of the plurality of objects, and information about the gender and age of the object based on the information about the relationship.

The selecting advertising content is selecting another piece of advertising content if the first or second eye direction information indicates that the time for which the direction of eyes has deviated from a direction toward the advertising content exceeds a predetermined time.

The selecting advertising content may be primarily selecting first advertising content based on the long-distance analysis information and, when the short-distance analysis information is created, selecting second advertising content based on the short-distance analysis information.

The selecting advertising content may be selecting another piece of advertising content if the second eye direction information indicates that the time for which the direction of eyes has deviated from the direction toward the advertising content exceeds a predetermined time.

The first eye direction information may be created based on one or more of the direction of the face of the object and the direction of the irises of the object are oriented. In contrast, the second eye direction information may be created based on one or more of the direction of the front of the upper body of the object and the direction of the front of the face of the object.

The method may further include interacting with each other to select advertising content by a user input unit and the content selection unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an apparatus for providing advertising content according to the embodiment of the present invention;

FIG. 2 is a diagram schematically showing the flow of the provision of advertising content;

FIG. 3 is a block diagram showing a detailed example of the constitution of a short-distance analysis unit;

FIG. 4 is a block diagram showing a detailed example of the constitution of a long-distance analysis unit;

FIG. 5 is a flowchart of a method of providing advertising content according to an embodiment of the present invention; and

FIG. 6 is a flowchart of a method of providing advertising content according to another embodiment of the present invention.

### DESCRIPTION OF THE PREFERRED EMBODIMENTS

Reference now should be made to the drawings, in which the same reference numerals are used throughout the different drawings to designate the same or similar components.

An apparatus and method for providing advertising content according to embodiments of the present invention will be described below with reference to the accompanying drawings.

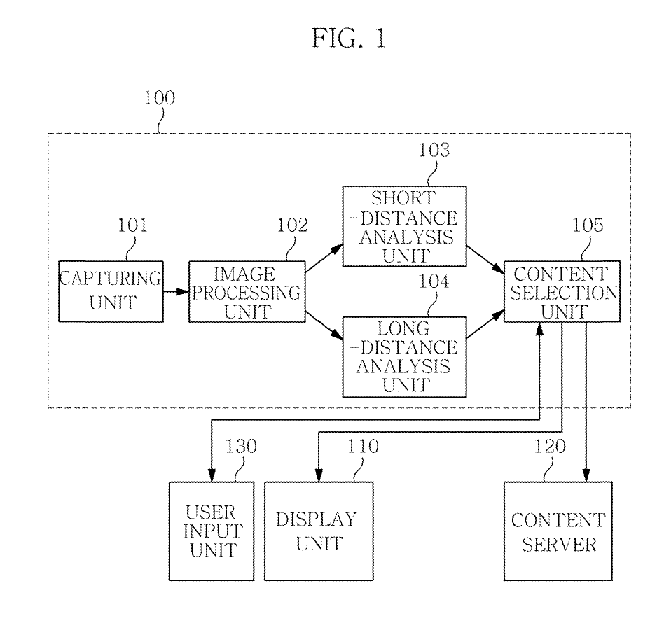

FIG. 1 is a block diagram of an apparatus 100 for providing advertising content according to an embodiment of the present invention.

Referring to FIG. 1, the apparatus 100 for providing advertising content according to this embodiment of the present invention includes an image processing unit 102, a short-distance analysis unit 103, a long-distance analysis unit 104, and a content selection unit 105. A capturing unit 101 may be connected to the image processing unit 102.

One or more of a content server 120, a display unit 110 and a user input unit 130 may be additionally connected to the content selection unit 105.

The image processing unit 102 functions to extract one or more objects from a captured image. The capturing unit 101 may be connected to the image processing unit 102, as described above. In this embodiment of the present invention, the term “object” refers to the user of advertising content.

The capturing unit 101 functions to capture an area near the display unit 110 while the display unit 110 is displaying advertising content. In this embodiment of the present invention, the capturing unit 101 is included in the apparatus 100 for providing advertising content. The apparatus 100 for providing advertising content may be installed in the display unit 110.

However, the capturing unit 101 may be separated from the apparatus 100 for providing advertising content because the apparatus 100 for providing advertising content may be managed by a single server. In this embodiment of the present invention, the capturing unit 101 is installed on the top of the display unit 110 to capture an area in the direction in which the display unit 110 outputs advertising content.

The capturing unit 101 functions to capture an area in front of the location where it is installed, as described above. In general, the capturing unit 101 may contain an image capturing camera inside it. However, any device, such as a digital camcorder, a small-sized cam, or an infrared camera, may be included in the capturing unit 101 as long as the device is capable of capturing an object in front of it.

The capturing unit 101 may be connected to the image processing unit 102 via a wired or wireless connection. The capturing unit 101 may include the functionality of sending a captured image to the image processing unit 102 in real time. The captured image is converted into a format which can be processed by the image processing unit 102, and is then sent to the image processing unit 102. The capturing unit 101 may send still image data periodically, for example, at intervals of 1 second, rather than sending an image in real time.

The image processing unit 102 receives the image captured by the capturing unit 101. The image processing unit 102 may include the functionality of eliminating noise from the received image data (real-time moving image or periodically received still image data) and smoothing the image.

The image processing unit 102 may include a module which separates the background and one or more objects in the image data. The image processing unit 102 may manage data obtained by extracting one or more objects from the image using the module. The data obtained by extracting only the objects is sent to the long-distance analysis unit 104 and the short-distance analysis unit 103.

The image processing unit 102 creates data obtained by extracting only one or more objects from the image. The image may be a moving image or a plurality of still images.

The long-distance analysis unit 103 functions to create long-distance analysis information which is obtained by analyzing the objects at a first distance.

In this embodiment of the present invention, the term “first distance” refers to a preset distance at which the movement of and directions of the eyes of the objects can be analyzed. For example, the first distance may be a distance of 3 meters from the capturing unit 101. It will be apparent that the first distance may refer to a precise numerical distance or a specific range around the first distance. For example, it may be a distance of 3 mm from the capturing unit 101 or a range of 3+0.5 meters.

The long-distance analysis unit 103 analyzes the objects at the first distance. When each of the objects at the first distance is analyzed, the analysis of the facial expression or facial elements of the object is inaccurate. Accordingly, the long-distance analysis unit 103 analyzes the movement and direction of the object.

In this embodiment of the present invention, long-distance analysis information may include object trajectory information and/or second eye direction information.

The term “object trajectory information” refers to information about the flow of the movement of the object included in the moving image or the series of still images captured by the capturing unit 101. The pattern of actions that occur while the object moves its physical parts may be also included in the trajectory information. For example, the pattern of stooping and moving may be included in the trajectory information.

The second eye direction information is used to determine whether the object is viewing advertising content currently being sent

In order to create the second eye direction information the functionality of estimating the direction of the eyes using captured images of the object is required.

In this embodiment of the present invention, in the long-distance analysis unit 104, the direction of the eyes of the object is set by analyzing the images of the object captured at the first distance. For example, the direction of the eyes of the object may be based on any one of the direction formed by the upper body of the object, that is, the direction in which the front of the upper body is oriented, and the direction in which the front of the face of the object is oriented. Since the capture at the first distance is not sufficiently accurate to correctly analyze the direction of the eyes, the direction of the eyes is determined based on the direction in which the front of the upper body or the face is oriented.

As a result, the above-described long-distance analysis information is used to determine whether the object is interested in the advertising content. For example, if it is determined based on the trajectory information that the object is approaching the display unit 110 which is displaying the advertising content, or it is determined that the second eye direction information of the object is consistent with the display unit 110, it can be determined that the object is interested in the advertising content currently being sent.

Accordingly, the long-distance analysis unit 104 provides one or more of the trajectory information and second eye direction information of the object to the content selection unit 105, so that the interest of the object can be determined.

The long-distance analysis information may further include information about the relationship between the previously created trajectory information of a plurality of objects and the previously created gender and age information of the plurality of objects.

The term “information about the relationship” refers to information about the relationship between the trajectory information of the long-distance analysis information and the gender and age information of the short-distance analysis information which are obtained by analyzing a plurality of objects using the long-distance analysis unit 104 and the short-distance analysis unit 103.

Accordingly, the long-distance analysis unit 104 may further include the functionality of managing the information about the relationship. The long-distance analysis unit 104 may estimate the average gender and age of the corresponding object depending on the current trajectory information of the object based on the information about the relationship. If the gender and age information of the object can be estimated based on the information about the relationship, the long-distance analysis information may further include the gender and age information of the object based on the information about the relationship.

In order to increase the trustworthiness of the information about the relationship, the long-distance analysis unit 104 may include the functionality of repeatedly updating the information about the relationship based on the trajectory information of the captured object and the gender and age information of the object obtained by the short-distance analysis unit 103. When the long-distance analysis unit 104 as well as the short-distance analysis unit 103 is allowed to estimate the gender and the age, the effect of increasing the accuracy of the age and gender analysis of the user can be achieved.

The short-distance analysis unit 103 functions to create short-distance analysis information at a second distance that is shorter than the first distance.

The short-distance analysis unit 103 analyzes an object at the second distance. In this embodiment of the present invention, the second distance refers to a distance which is closer to the capturing unit 101 than the first distance (or a predetermined range around the first distance, for example, a distance of 3 meters from the capturing unit 101 or a range of 3±0.5). The distance close to the capturing unit 101 means that the distance between the capturing unit 101 and the object is shorter than the first distance.

For example, the second distance may be a distance of 1 meter from the capturing unit 101 or display unit 110, or a range of 1±0.3 meters. The second distance may be any distance as long as the short-distance analysis unit 103 can analyze the facial elements of the object or the direction of the eyes based on a facial expression and the irises at the distance.

The short-distance analysis information created by analyzing the information of the object obtained at the second distance may include one or more of the facial, gender, age and first eye direction information.

The facial information of the object refers to information about the facial elements of the object. For example, it may include the shape of the hair, the eyes, the nose, the mouth, the contour of the face, and facial skin characteristics.

The short-distance analysis unit 103 extracts the gender and age information of the object by analyzing the facial information of the object. The gender and age information of the object is selected from gender and age information corresponding to the accumulated facial information of objects.

For example, it is possible to estimate age information based on the shape of hair. Furthermore, the age and the gender can be estimated based on information about the size of the contour and shape of the face. It may be possible to estimate age information based on information about the extent of wrinkles which appears in facial skin characteristics.

Accordingly, the short-distance analysis unit 103 may include the functionality of managing information about the relationship between the facial information and the information about the age and gender of the object measured at the second distance. The short-distance analysis unit 103 has the ability to learn and learns information about the above-described relationship, and, more accurately, can estimate information about the age and gender of the object.

The first eye direction information of the object is created to determine the direction of the eyes of the object in addition to the second eye direction information created by the long-distance analysis unit 104. The first eye direction information of the object included in the short-distance analysis information is created based on the irises of the object and the direction in which the front of the face is oriented. Since it is difficult to determine the direction in which the object faces using only the direction in which the face of the object is oriented, the direction in which the irises of the object are oriented is determined.

The first eye direction information of the object included in the short-distance analysis information, together with the second eye direction information of the object included in the long-distance analysis information, is transferred to the content selection unit 105 in order to determine whether the object is interested in the advertising content.

The content selection unit 105 functions to select the advertising content using the long-distance analysis information and the short-distance analysis information.

The content selection unit 105 receives the long-distance analysis information and the short-distance analysis information from the long-distance analysis unit 104 and the short-distance analysis unit 103, respectively. Thereafter, the long-distance analysis information and the short-distance analysis information are analyzed in an integrated manner, the age and gender information of the object is accurately estimated, and the advertising content is selected based on the estimated age and gender information of the object and whether the object is interested in advertising content currently being sent.

For example, it is assumed that an old man in his sixties has been captured by the capturing unit 101 of the apparatus 100 for providing advertising content. That is, it is assumed that the object is an old man in his sixties. Furthermore, it is assumed that the advertising content currently being sent to the display unit 110 is advertising content for shoes.

If the old man in his sixties becomes interested in the advertising content for shoes, his eyes may remain fixed for a predetermined time or may move toward the display unit 110. When the object arrives at the first distance, the long-distance analysis unit 104 creates long-distance analysis information, that is, the trajectory information of the object.

For example, one or more of trajectory information indicating that the object stoops and is approaching advertising content, second eye direction information indicating that the upper body and the face are oriented to the advertising content, information about the age of the object estimated based on the stooping of the object, and information about the gender of the object estimated based on the height and bodily shape of the object may be created. The created long-distance analysis information is transferred to the content selection unit 105.

When the object approaches the display unit 110, it is possible to create the short-distance analysis information. The long-distance analysis information created by the long-distance analysis unit 104 may have been stored in the content selection unit 105. When the object arrives at the second distance, the short-distance analysis unit 103 creates the short-distance analysis information.

For example, information about the shape of hair (for example, a bold head), information about the wrinkles in the skin and first eye direction information related to advertising content (for example, the fixation of the eyes on advertising content), which are included in the face of the object, may be created. The short-distance analysis information may be also transferred to the content selection unit 105.

The content selection unit 105 selects advertising content to be sent to the display unit 110 based on the received long-distance analysis information and short-distance analysis information, that is, based on information about the gender and age of the user and whether the user is interested in the advertising content for shoes that is currently being sent.

In the above example, if it is determined that the object is oriented to the advertising content for shoes, the content selection unit 105 may continuously send the advertising content for shoes. Alternatively, when information about the age and gender of the object estimated based on the long-distance analysis information and the short-distance analysis information, for example, the information “a male in his sixties,” is received, the content selection unit 105 may select advertising content for shoes having acupressure functionality or health shoes, and provide it to the display unit 110.

Like the above-described example, the content selection unit 105 selects advertising content to be sent based on the long-distance analysis information and the short-distance analysis information.

As described above, the content selection unit 105 may include the functionality of determining whether the object is interested in the advertising content in connection with the selection of the content.

In this embodiment of the present invention, the criteria for determining whether there is an interest in the advertising content currently being sent may reside in the first and second eye direction information. Whether the object is interested in the advertising content may be determined by both the long-distance analysis unit 104 and the short-distance analysis unit 103, as described above. The reason for this is all the first and second eye direction information can be created by the long-distance analysis unit 104 and the short-distance analysis unit 103.

In this embodiment of the present invention, the determination of whether the object is interested in the advertising content is determined based on whether the time for which the first or second eye direction information has deviated from the direction toward the advertising content exceeds a predetermined time.

If the object is interested in the advertising content currently being sent, the eyes of the object should remain fixed in the direction toward the advertising content continuously or for a sufficiently long time. Accordingly, if the time for which the direction toward the advertising content or display unit has been inconsistent with the first or second eye direction information exceeds the predetermined time, it may be determined that the object is not interested in the advertising content currently being sent.

Accordingly, the content selection unit 105 may include the functionality of selecting another piece of advertising content if the time for which the first and/or second eye direction information created by the long-distance analysis unit 104 and the short-distance analysis unit 103 has deviated from the direction toward the advertising content exceeds the predetermined time. In this case, it is determined that the object is not interested in advertising content currently being sent, and another piece of content is selected. The criteria for selecting another piece of content may be the estimated gender and age of the object.

The content selection unit 105 may be connected to the content server 120. In the content server 120, a plurality of pieces of advertising content may be organized into and managed in a database. In the database managed by the content server 120, the information of the plurality of pieces of advertising content and information about target gender and ages for each piece of advertising content may be stored.

For example, it is assumed that advertising content for children's shoes is most suitable for the female gender for an age falling in the twenties and thirties. In this case, the advertising content for children's shoes may be stored in the content server 120, along with tag information related to the advertising content for children's shoes, that is, the information about the female gender for an age falling in the twenties and thirties.

In order to provide accurate advertising content, the content selection unit 105 may select advertising content based on the long-distance analysis information and advertising content based on the short-distance analysis information in different ways.

That is, the content selection unit 105 may include the functionality of selecting first advertising content based on the long-distance analysis information and then selecting second advertising content based on the short-distance analysis information when the short-distance analysis information is created.

The above-described example is again taken up for consideration. It is assumed that an old man in his sixties has been captured by the capturing unit 101 of the apparatus 100 for providing advertising content. That is, it is assumed that the object is an old man in his sixties. Furthermore, it is assumed that the advertising content currently being sent to the display unit 110 is advertising content for shoes.

When the object arrives at the first distance, the long-distance analysis information of the object is created by the long-distance analysis unit 10. For example, information indicating the stooping of the object, trajectory information indicating that the object is approaching the display unit 110, second eye direction information indicating whether the upper body and the face are continuously oriented to the display unit 110 to which the advertising content is being sent, and the estimated information “a female in her fifties or more” may be created.

In this case, the content selection unit 105 may determine that the object is interested in the advertising content for shoes that is currently being sent, and continuously sends the advertising content for shoes. More preferably, advertising content corresponding to tag information related to the estimated age of the object, for example, advertising content for health shoes, may be selected and sent.

While the object is located at the first distance, the long-distance analysis unit 104 and the content selection unit 105 may repeat the above-described functionality.

If the object arrives at the second distance, the short-distance analysis information of the object may be created. For example, as a result of the analysis of facial information, age and gender information, that is, a male in his sixties, may be created. Furthermore, information indicating that the irises of an object are fixed on a location beside the display unit 110, rather than information about the direction of the eyes oriented to the display unit 110 to which the advertising content is being sent, may be created as the first eye direction information.

In this case, the content selection unit 105 determines that the object is not interested in the advertising content currently being sent. Furthermore, the advertising content is selected using the keyword “a male in his sixties.” For example, advertising content for health food may be selected.

Thereafter, while the object has been at the second distance, the short-distance analysis unit 103 and the content selection unit 105 may repeatedly perform the above-described functionality. For example, it is assumed that advertising content for health food is newly selected and sent. In this case, it is determined that the direction of the eyes of an object does not deviate from the direction toward the advertising content. At this time, the content selection unit 105 may continuously sent the advertising content for health food.

By performing the series of functionalities, the apparatus for providing advertising content according to the embodiment of the present invention can achieve the effect of accurately determining information about the user and actively selecting and providing advertising content in response to the information about the user.

That is, whether the user is interested in the advertising content currently being provided can be accurately determined by analyzing the trajectory information and direction of the eyes of the user at a long distance. Furthermore, information about the gender and age of a user can be accurately extracted based on the analysis of still images at a short distance and the action pattern (trajectory information) of the user at a long distance. Since user-customized advertising content is provided based on precisely extracted information, the effect of increasing the efficiency of the provision of advertising content can be achieved.

In another embodiment of the present invention, the user input unit 130 may be connected to the content selection unit 105.

The user input unit 130 refers to any device which enables an object to directly search for, select and use advertising content. For example, the user input unit 130 may be a touch screen disposed on a side of the display unit 110. Since the user input unit 130 is connected to the content selection unit 105, the effect of enabling the interaction related to the selection of advertising content between the content selection unit 105 and the object can be achieved.

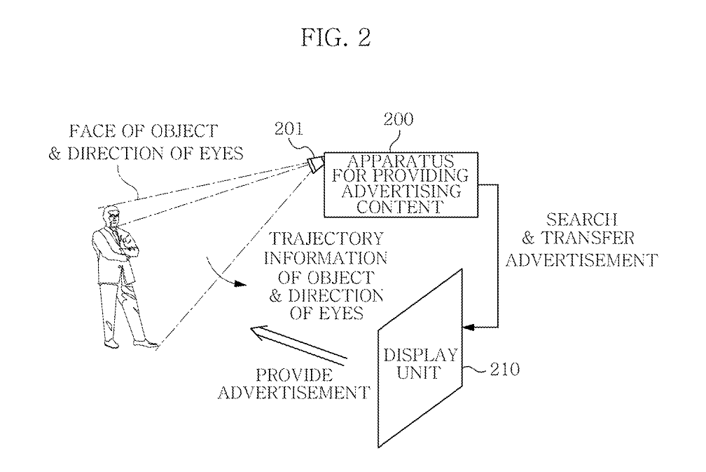

FIG. 2 schematically shows the flow of the provision of advertising content. In the following description, descriptions identical to those given in conjunction with FIG. 1 will be omitted.

Referring to FIG. 2, when an object (in FIG. 2, an advertising content user) arrives at the first distance or second distance, the capturing unit 201 captures the object, and collects image data.

An apparatus 200 for providing advertising content (an apparatus for managing the provision of advertisements) searches for and provides an advertisement based on the gender and age of the user and whether the user is interested in advertising content currently being sent. A display unit 210 displays the advertisement to the object.

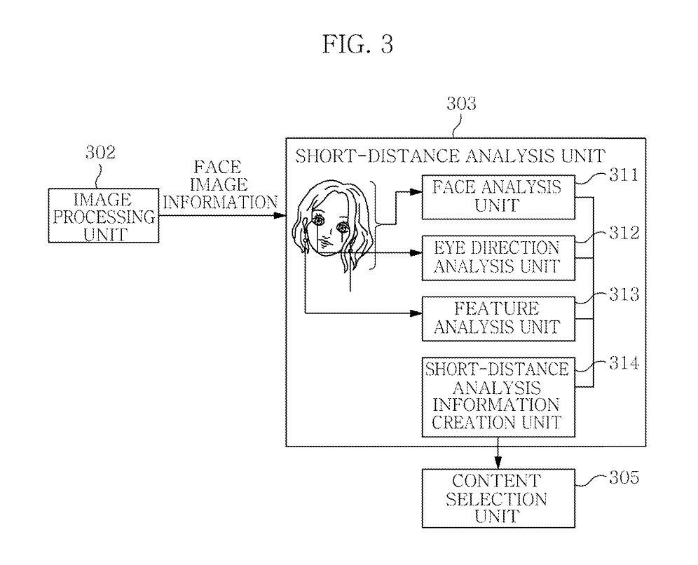

The display unit 210 refers to any device which is capable of displaying advertising content so that the object can perceive it. For example, an image playback device including a TV, a speaker, and a 3D hologram projector may be included in the display unit 210. FIG. 3 is a block diagram showing a detailed example of the implementation of the short-distance analysis unit. In the following description, descriptions identical to those given in conjunction with FIGS. 1 and 2 will be omitted.

Referring to FIG. 3, the short-distance analysis unit 303 receives image data (for example, facial image data) at the second distance from the image processing unit 302. The short-distance analysis unit 303 may include a face analysis unit 311, an eye direction analysis unit 312, a feature analysis unit 313, and a short-distance analysis information creation unit 314. The short-distance analysis information creation unit 314 is connected to a content selection unit 305.

The face analysis unit 311 functions to analyze the face of an object. For example, the face analysis unit 311 may analyze the features of facial elements, the size and shape of a facial contour, wrinkle information, and the shape of hair.

The eye direction analysis unit 312 analyzes the irises of the object and the direction in which the face of the object is oriented, and creates the first eye direction information of the object.

The feature analysis unit 313 functions to analyze all information related to the estimation of the age and gender of the object, except for the information analyzed by the face analysis unit 311 and the eye direction analysis unit 312. For example, when the object wears earrings on his or her ears, the presence of the earrings included on the face can be detected.

The short-distance analysis information creation unit 314 creates short-distance analysis information based on the information resulting from the analysis carried out by the face analysis unit 311, the eye direction analysis unit 312, and the feature analysis unit 313. The created short-distance analysis information is sent to the content selection unit 305 in real time.

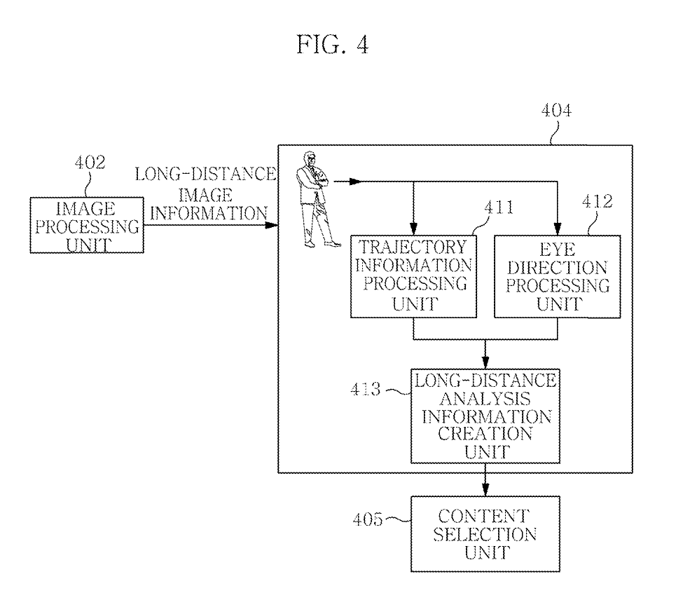

FIG. 4 is a block diagram showing a detailed example of the implementation of the long-distance analysis unit. In the following description, descriptions identical to those given in conjunction with FIGS. 1 and 3 will be omitted.

Referring to FIG. 4, a long-distance analysis unit 404 receives image data (for example, the image data of the entire object) at the first distance from an image processing unit 402. The long-distance analysis unit 404 may include a trajectory information processing unit 411, an eye direction processing unit 412, and a long-distance analysis information creation unit 413. The long-distance analysis information creation unit 413 is connected to a content selection unit 405.

The trajectory information processing unit 411 analyzes the movement or action characteristics of each object extracted from a plurality of images or a moving image. By doing so, the trajectory information of the object is created, and the trajectory information may include information about physical action characteristics, in addition to the direction of movement.

The eye direction processing unit 412 creates second eye direction information, that is, the results of estimating the direction of the eyes, based on the direction of the upper body and face of the object extracted from a plurality of still images or a moving image.

The long-distance analysis information creation unit 413 functions to create long-distance analysis information obtained by combining the trajectory information with the second eye direction information, and transfer the long-distance analysis information to the content selection unit 405.

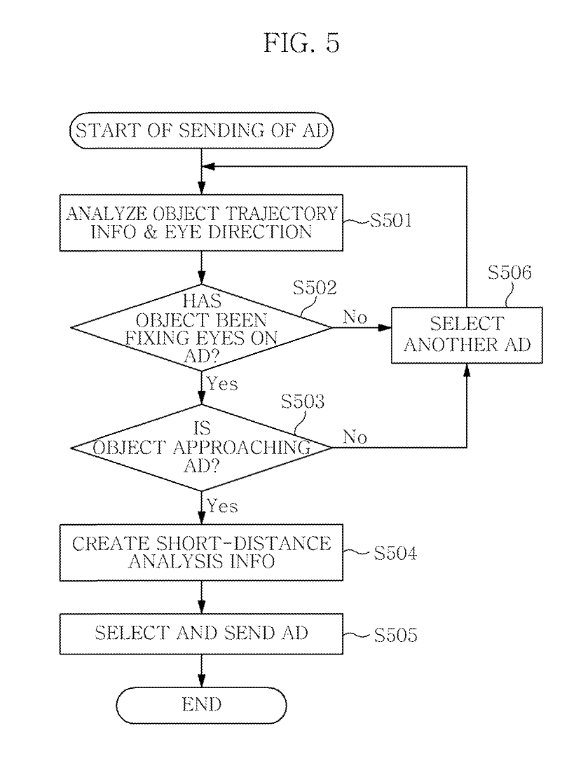

FIG. 5 is a flowchart of a method of providing advertising content according to an embodiment of the present invention. In the following description, descriptions identical to those given in conjunction with FIGS. 1 to 4 will be omitted.

Referring to FIG. 5, the method of providing advertising content according to this embodiment of the present invention includes the steps of the long-distance analysis unit creating long-distance analysis information obtained by analyzing at least one object extracted from an image at a first distance; the short-distance analysis unit creating short-distance analysis information obtained by analyzing the object at a second distance shorter than the first distance; and the content selection unit selecting advertising content using the long-distance analysis information and the short-distance analysis information.

The step of creating long-distance analysis information comprises the step S501 of, when the object arrives at the first distance, extracting the object by processing an image, captured by the capturing unit, using the image processing unit, and creating trajectory information and second eye direction information by analyzing the trajectory and direction of eyes of the extracted object using the long-distance analysis unit.

The step S504 of creating short-distance analysis information is also performed. In greater detail, the step S504 may be the step of, when the object arrives at the second distance, creating the facial information of the object, gender and age information obtained by analyzing the facial information, and first eye direction information.

Thereafter, the step S505 of the content selection unit selecting advertising content using the long-distance analysis information and the short-distance analysis information is performed.

In this embodiment of the present invention, the step S505 of selecting advertising content may be the step of primarily selecting first advertising content based on the long-distance analysis information, and, after the short-distance analysis information has been created, selecting second advertising content based on the short-distance analysis information.

Accordingly, as shown in FIG. 5, each of steps S501 and S504 may include a plurality of steps related to the above-described sequential selection of content.

First, when the object arrives at the first distance, long-distance analysis information is created. The step S502 of the content selection determining whether the object is focusing his or her eyes on the advertisement, that is, whether the object is interested in the advertising content currently being sent, based on the second eye direction information included in the unit long-distance analysis information is performed.

If it is determined that the object is not interested in advertising content currently being sent, the step S506 of the content selection unit selecting another piece of advertising content based on the information about the estimated gender and age of the object included in the long-distance analysis information is performed.

If it is determined that the object is interested in the advertising content based on the long-distance analysis information of the object, the step S503 of determining whether the object is approaching the advertising content currently being sent or the display unit is performed. If the object is not approaching the advertising content, the step S506 is performed again. If the object performs the approach and arrives at the second distance, the step S504 is performed.

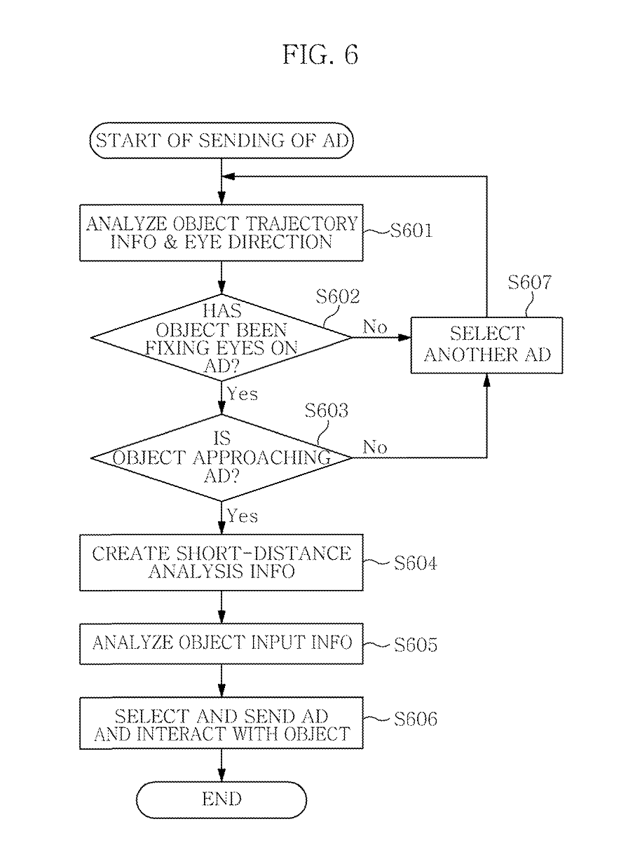

FIG. 6 is a flowchart of a method of providing advertising content according to another embodiment of the present invention. In the following description, descriptions identical to those given in conjunction with FIGS. 1 to 5 will be omitted.

Referring to FIG. 6, the method of providing advertising content according to the other embodiment of the present invention further includes the steps of the long-distance analysis unit creating long-distance analysis information obtained by analyzing at least one object extracted from an image at a first distance; the short-distance analysis unit creating short-distance analysis information obtained by analyzing the object at a second distance shorter than the first distance; and the content selection unit selecting advertising content using the long-distance analysis information and the short-distance analysis information; wherein the content selection unit selecting advertising content includes the step of selecting content using the interaction between the user input unit and the content selection unit.

First, the step of creating long-distance analysis information comprises the step S601 of, when the object arrives at the first distance, the image processing unit extracting an object by processing an image captured by the capturing unit, and long-distance analysis unit creating trajectory information and second eye direction information by analyzing the trajectory and direction of eyes of the extracted object.

The step S604 of creating short-distance analysis information is also performed. In greater detail, the step S604 may be the step of, when the object arrives at the second distance, creating the facial information of the object, gender and age information obtained by analyzing the facial information, and first eye direction information.

Thereafter, the step S605 of the content selection unit analyzing input information about the selection of advertising content by the object, that is, by a user, that was received from the user input is performed. Thereafter, the step S606 of the content selection unit selecting and sending an advertisement based on interaction with the user input, the long-distance analysis information, and the short-distance analysis information is performed.

In this embodiment of the present invention, the step S606 of selecting advertising content may be the step of primarily selecting first advertising content based on the long-distance analysis information and, when short-distance analysis information is selected, selecting second advertising content based on the short-distance analysis information.

Accordingly, as shown in FIG. 6, each of steps S601 and S604 may include a plurality of steps related to the above-described sequential selection of content.

First, when the object arrives at the first distance, long-distance analysis information is created. The step S602 of determining whether the object is focusing his or her eyes on an advertisement, that is, whether the object is interested in advertising content currently being sent based on the second eye direction information included in the long-distance analysis information is performed by the content selection unit.

If it is determined that the object is not interested in advertising content currently being sent, the step S607 of the content selection unit selecting another piece of advertising content based on information about the estimated gender and age of the object included in the long-distance analysis information is performed.

If it is determined that the object is interested in the advertising content based on the long-distance analysis information of the object, the step S603 of determining whether the object is approaching the advertising content currently being sent or the display unit is performed. If the object is not approaching the advertising content, the step S607 is performed again. If the object performs the approach and arrives at the second distance, the step S604 is performed.

The present invention has the advantage of being able to accurately determine whether a user is interested in advertising content being currently provided by analyzing the trajectory information and the direction of the eyes of the user at a long distance. Furthermore, the present invention has the advantage of being able to accurately extract information about the gender and age of a user based on the analysis of still images at a short distance and the action pattern (trajectory information) of the user at a long distance. Moreover, the present invention has the advantage of being able to provide user-customized advertising content based on accurately extracted information, thereby increasing the efficiency of the provision of advertising content.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for providing advertising content, comprising:
an image processing unit for extracting an object from a captured image;
a long-distance analysis unit for creating long-distance analysis information obtained by analyzing the object at a first distance;
a short-distance analysis unit for creating short-distance analysis information obtained by analyzing the object at a second distance shorter than the first distance; and
a content selection unit for selecting an advertising content based on the long-distance analysis information and the short-distance analysis information.

2. The apparatus of claim 1, wherein the short-distance analysis information includes one or more of information about a face of the object, information about a gender of the object, information about an age of the object, and first eye direction information.

3. The apparatus of claim 2, wherein the content selection unit comprises functionality of selecting another piece of advertising content if the first eye direction information indicates that a time for which a direction of eyes has deviated from a direction toward the advertising content exceeds a predetermined time.

4. The apparatus of claim 2, wherein the first eye direction information is created based on one or more of a direction of the face of the object and a direction of irises of the object.

5. The apparatus of claim 1, wherein the long-distance analysis information includes one or more of trajectory information of the object and second eye direction information.

6. The apparatus of claim 5, wherein the long-distance analysis information further includes information about a relationship between previously created trajectory information of a plurality of objects and previously created gender and age information of the plurality of objects, and information about a gender and age of the object based on the information about a relationship.

7. The apparatus of claim 5, wherein the second eye direction information is created based on one or more of a direction of a front of an upper body and a direction of a front of a face of the object.

8. The apparatus of claim 5, wherein the content selection unit comprises functionality of selecting another piece of advertising content if the second eye direction information indicates that a time for which a direction of eyes has deviated from a direction toward the advertising content exceeds a predetermined time.

9. The apparatus of claim 6, wherein the long-distance analysis unit further comprises functionality of updating the information about the relationship based on the information about a gender and age of the object and the trajectory information.

10. The apparatus of claim 1, wherein the content selection unit comprises functionality of primarily selecting first advertising content based on the long-distance analysis information and, when the short-distance analysis information is created, selecting second advertising content based on the short-distance analysis information.

11. A method of providing advertising content, comprising:
creating long-distance analysis information obtained by analyzing an object extracted from an image at a first distance, by a long-distance analysis unit;
creating short-distance analysis information obtained by analyzing the object at a second distance shorter than the first distance, by a long-distance analysis unit; and
selecting an advertising content using the long-distance analysis information and the short-distance analysis information by a content selection unit.

12. The method of claim 11, wherein the short-distance analysis information includes one or more of information about a face of the object, information about a gender of the object, information about an age of the object, and first eye direction information.

13. The method of claim 12, wherein the selecting advertising content is selecting another piece of advertising content if the first eye direction information indicates that a time for which a direction of eyes has deviated from a direction toward the advertising content exceeds a predetermined time.

14. The method of claim 12, wherein the first eye direction information is created based on one or more of a direction of the face of the object and a direction of irises of the object.

15. The method of claim 11, wherein the long-distance analysis information includes one or more of trajectory information of the object and second eye direction information.

16. The method of claim 15, wherein the long-distance analysis information further includes information about a relationship between previously created trajectory information of a plurality of objects and previously created gender and age information of the plurality of objects, and information about a gender and age of the object based on the information about a relationship.

17. The method of claim 15, wherein the second eye direction information is created based on one or more of a direction of a front of an upper body and a direction of a front of a face of the object.

18. The method of claim 16, further comprising updating the information about a relationship based on the information about a gender and age of the object and the trajectory information, by the long-distance analysis unit.

19. The method of claim 15, wherein the selecting advertising content is selecting another piece of advertising content if the second eye direction information indicates that a time for which a direction of eyes has deviated from a direction toward the advertising content exceeds a predetermined time.

20. The method of claim 11, wherein the selecting advertising content is primarily selecting first advertising content based on the long-distance analysis information and, when the short-distance analysis information is created, selecting second advertising content based on the short-distance analysis information.
